(19) United States
(12) Patent Application Publication
(10) Pub. No.: US 2002/0109729 A1
(43) Pub. Date: Aug. 15, 2002

(54) Integrating content with virtual advertisements using vector graphics images obtainable on the web

(76) Inventor: Rabindranath Dutta, Austin, TX (US)

Correspondence Address: Leslie A. Van Leeuwen, International Business Machines Corp., 11400 Burnet Rd. - 4054, Austin, TX, 78758, US

(21) Appl. No.: 09/736,414

(22) Filed: Dec. 14, 2000

(51) Int. Cl. G09G 5/00

(52) U.S. Cl. 345/790

(57) ABSTRACT

A system and method for virtual advertising on the web are disclosed. According to this system and method, scalable vector graphic (SVG) images representing advertising content may be inserted into web pages so that they are unobtrusively superimposed over other SVG images on the page. This technique is analogous to the familiar practice in television of electronically inserting advertising images into an image before it is broadcast. An ad server, working cooperatively with a web server, provides SVG virtual advertising images to be placed on web pages requested by a client. Since SVG image files are text-based, they are easily edited. Thus, the ad server, web server or client can modify the image to include a virtual advertisement.

### BACKGROUND OF THE INVENTION

1. Field of the Invention

This invention is related to the field of image compilation from dissimilar computational devices usable with Internet technology and, more particularly, to the merging of vector graphic images obtainable, for example, from Internet web pages.

2. Description of the Related Art

Modem video technology has made it possible to combine electronically generated images with the image produced from a video camera. A familiar example of this is the goal line seen in the televised image of the playing field during a football game. The goal line does not actually appear on the playing field; rather, it is electronically inserted into the image received from the camera before the image is transmitted to the viewing audience. A similar technology has also been used to insert “virtual advertisements” into commercial television programs. During a scene from a movie, for example, the call letters of the TV station may be unobtrusively displayed in the lower right comer of the image on the screen. As in the previous case, the call letters are not part of the original video content, but are inserted electronically into the image before it is transmitted.

Virtual billboard advertisements can be introduced into a variety of television broadcasts, examples of which include briefly superimposing the “Coke” logo over a portion of the audience during a tennis match. When overlaying advertising or other content on a video image, it is important to avoid obstructing regions of interest within the image. In the case of the televised tennis match, for example, it would not do to place the “Coke” logo directly over the players. The identification of suitable regions can be done by production personnel, or by judicious software algorithms.

The application of virtual advertising to Internet web pages has significant commercial potential. It is estimated that Americans spend 9% of their daily media time on the Internet, but only about 2% of ad dollars are allocated to web advertising. Thus, Internet advertising, though relatively underutilized, is capable of reaching a very large prospective market. Companies owning web sites currently sell space on their web page to advertisers, who in turn, contract Internet advertising networks to display ads for their product in the purchased space. The advertising networks typically maintain their own ad servers to store advertisements and deliver them to the web client. When a user clicks on a company's Web address, the web server sends him the desired web page, embedded in which, is a hyperlink to the ad server. The ad server then sends the ad content, which is inserted around the important content of the page.

A great deal of web advertising content consists of graphic images. In fact, graphic images may account for as much as 50% of all Internet traffic. This is attributable to the fact that most graphic images appearing on the Internet are based on bit-mapped (or “raster”) formats. Bit-mapped images are represented in terms of pixels—i.e., individual picture elements defining the brightness and/or color of a small segment of the image. The sharpness, or precision of a bit-mapped image is a function of the number of pixels used. Using a large number of very small pixels yields the best definition in the image. Consequently, high-resolution bit-mapped image files are typically quite large. For example, assuming each pixel requires three bytes of storage, a color digital camera with a resolution of 2048×1536 pixels produces a bit-mapped image requiring 3,145,728 bytes of storage. Fortunately, the image needn't be saved in its “raw” bit-mapped format. There are a variety of image compression techniques for reducing the amount of stored data. Such techniques are the basis for popular image formats, such as Joint Photographic Experts Group (JPEG), Graphics Interchange Format (GIF), and Portable Network Graphics (PNG). Even with such measures, bit-mapped images are often unwieldy.

A further disadvantage of bit-mapped images is that they are not scalable. This is because the pixels in a bit-mapped image represent the ultimate level of detail. When a bit-mapped image has been scaled to the point where individual pixels are apparent, further magnification yields no additional scene detail. A familiar example of this is the photographs appearing in the newspaper. When viewed at the appropriate distance, these photos contain recognizable images of people and places in the day's news. Through a magnifying glass, however, the photos are seen to consist of numerous small dots of varying shades of gray. These dots are equivalent to the pixels of a bit-mapped image. Therefore, if we were to take the 3″×4″ picture of the presidential candidate on the front page and scale it to fill the entire page, we would not see additional detail (such as the pattern on his necktie), we would simply get a larger, but very fuzzy, image. This characteristic of bit-mapped images is a disadvantage for Internet images, which are commonly scaled to accommodate the space available on various web pages.

Vector graphics and in particular Scalable Vector Graphics (SVG) is emerging as an alternative to bit-mapped graphics for web images. One reason for the success of SVG images is that, unlike bit-mapped images, they are completely scalable. SVG images are more akin to a description of a scene than a facsimile. Instead of representing an image as a collection of pixels, SVG images consist of parametric statements, which define characteristics of the image. For example, the following SVG statement provides a vector graphic definition for the image below:

<rect x=“10”y=“10”height=“10”width=“10”style=“fill:lightblue”/>

The SVG statement creates a box, specified by the coordinates of the upper left corner (e.g., x=10, y=10), the height (e.g., h=10) and the width (w=10). The same SVG statement fills the box with the color light blue. Note that this mathematical description is completely scalable, since the size of the box is defined in terms of coordinates. It is a simple matter to enlarge or shrink the box, merely by adjusting the coordinate system. Thus, the lower corner of the box could as easily be (e.g., 10 mm, 10 mm) for a postage stamp graphic, or (e.g., 10 m, 10 m) for a billboard. Furthermore, the SVG file describing the box image is extremely compact; it consists of only a single line of text, rather than millions of pixels.

It must be pointed out that the compactness of SVG images is a function of image content. Elementary geometric shapes, such as the box, may be characterized using only a few parametric SVG statements, while complex and irregular shapes require more verbose descriptions. In most cases, however, an SVG image is more compact than an equivalent bit-mapped image, and takes less time to download to the client. This feature, together with their scalability, makes SVG images a likely replacement for bit-mapped images on the Internet.

In addition to the above benefits, SVG images may provide opportunities to enhance virtual web advertising. Many of the features associated with virtual advertising on television can be adapted to web advertising through the use of scalable vector graphics. It should be noted, however, that other types of vector graphics images such as postscript or PDF are also prevalent. As set forth hereinbelow, SVG subsumes or includes other such images and, according, those terms are used interchangeable.

### SUMMARY OF THE INVENTION

The potential for advertising on the Internet is presently underutilized. The amount of money spent on Internet advertising is not commensurate with the number of Internet users and the amount of time they typically spend online. One reason for this may be that, until recently, Internet support for graphic images has been very limited. Bit-mapped graphics formats, most commonly used on the Internet, have proven too large to permit rapid transmission of high quality images, and too inflexible to allow animation, zooming, and other effects to which television viewers have long been accustomed.

The vector graphic, PDF, etc., inclusive of scalable vector graphic (SVG) image format overcomes these limitations, allowing images to be represented more compactly. While an embodiment is described as to SVG, it is understood that the term SVG can reference the SVG language or it can represent generically any scalable vector graphic language, such as postscript, PDF, etc. Because it is a text-based format, image attributes are easily modified, making it possible to manipulate (e.g., scaling, rotating, panning, etc.) SVG images in a variety of ways. The enhanced capabilities of SVG graphics is expected to contribute to a wider use of advertising on the web.

Disclosed herein are a system and method for virtual advertising on the Internet, based on the use of scalable vector graphics. In this system, a client requests a web page, with an embedded link to a first SVG image, from a server. An ad server provides a second SVG image, comprising the virtual advertisement, which is inserted into the first SVG image before sending it to the client. When received by the client, the requested web page contains a modified version of the first SVG image, in which the virtual advertisement is superimposed over a portion of the original image. In the system and method disclosed herein the SVG images are represented as text-based files, and operations on SVG images are accomplished by editing the associated SVG image files.

In an embodiment of the system, the file corresponding to the first SVG image is modified by an editor in the web server to include code from the file corresponding to the second SVG image (i.e., the virtual advertisement). To perform this modification, the web server receives a copy of the second SVG image file from the ad server. The web server sends the requested web page and modified SVG image to the client. When rendered by the client, the modified SVG image combines the first and second SVG images, with the second overlaying a portion of the first.

In another embodiment, the ad server receives a copy of the first SVG image from the web server and modifies it to include the virtual advertisement. In this case, the embedded link to the graphic image in the web page sent to the client points to the ad server. Thus, the client gets the web page from the web server and the modified SVG image from the ad server.

In yet another embodiment, the web page received from the web server by the client contains a link to a first SVG image in the web server. Embedded in this first SVG image is a link to a second SVG image (the virtual advertisement) contained in the ad server. The client gets the first SVG image from the web server, and (following the contained link) gets the second SVG image from the ad server. An automated editor in the client overlays a portion of the first SVG image with the second, so the rendered image contains the virtual advertisement. The editor is merely software executable within any execution unit, including the web server, ad server or client, or neither the web server, ad server or client but some execution unit altogether separate from the web server, ad server or client.

The system and method disclosed herein further contemplate the use of a database within the ad server, which matches virtual advertisement images with primary SVG images. This database represents the arrangement between the website owner and the advertiser, whereby the advertiser is allowed to place ads only in specified regions within certain images. The database may contain information relating to the position and size of the virtual ad image. It may also incorporate regional, seasonal, or other dependencies, so that advertising content can be “targeted” to particular markets. Furthermore, the database may be created by a computer program, employing optimizing algorithms to determine placement of the ad, or ad content.

### BRIEF DESCRIPTION OF THE DRAWINGS

Other objects and advantages of the invention will become apparent upon reading the following detailed description and upon reference to the accompanying drawings in which:

FIG. 1 illustrates the use of virtual advertising on television;

FIG. 2 contains an example of SVG code and the corresponding image;

FIG. 3 illustrates scaling and the inclusion of bit-mapped graphics in an SVG image;

FIG. 4 shows the major components in an embodiment of the system and method disclosed herein for virtual advertising on the web;

FIG. 5 contains a flowchart, for a first embodiment of the system and method disclosed herein;

FIG. 6 contains a flowchart, for a second embodiment of the system and method disclosed herein;

FIG. 7 shows the major components in another embodiment of the system and method disclosed herein for virtual advertising on the web; and

FIG. 8 contains a flowchart, for a third embodiment of the system and method disclosed herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but rather, to cover all modifications, equivalents and alternatives falling within the spirit and scope of the present invention as defined by the appended claims.

### DETAILED DESCRIPTION OF THE PREFERRED EMBODIMENTS

Virtual advertising is a technique widely used in television for electronically superimposing commercial images over selected portions of a televised scene. An example of this is when the “Nike” logo abruptly appears on a section of the playing field during a televised soccer match. For such events, the television network typically sells time to advertisers beforehand. Then, at various points throughout the game, logos or other promotional images are electronically “dubbed” into the scene. At each point, an appropriate region within the scene is selected, where the promotional image will be inserted. This selection must take into account the size of the inserted image and the composition of the scene, since the virtual advertisement should not obstruct the main area of interest in the scene.

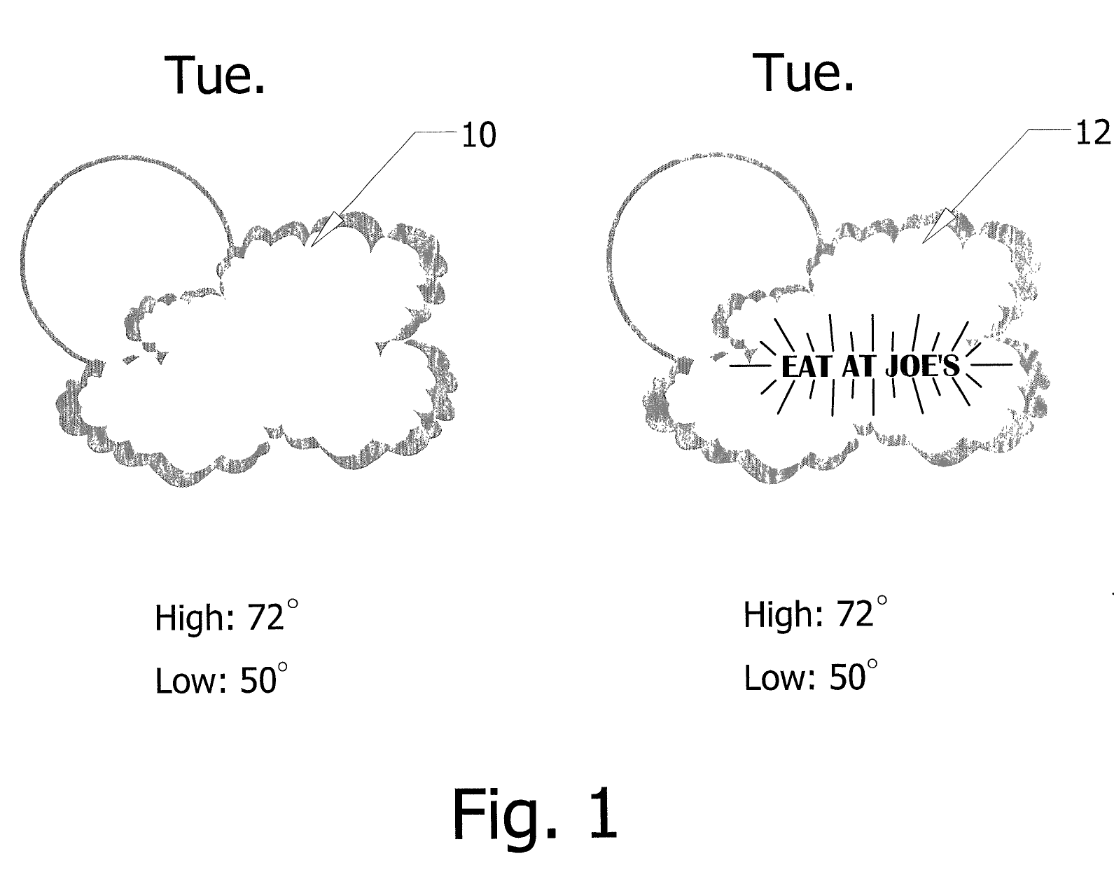

This idea is illustrated in FIG. 1, which depicts the insertion of a virtual advertisement into a televised weather forecast. The image at the left 10 in FIG. 1 represents the unaltered video, containing a picture of the sun behind a cloud (suggesting partly sunny skies), along with a projected temperature range and the date of the forecast. Note that there is a fairly large region within the picture of the sun behind the cloud in unaltered image 10 that contains no information. Such regions are suitable sites for virtual advertisements. In the image at the right 12 in FIG. 1, an advertisement has been electronically inserted over the cloud, where it does not obscure any important content.

Since a virtual advertisement is not part of the original televised image, it can be added at any point before the image is broadcast to the intended viewers. This is advantageous, since it allows regionally oriented advertising to be inserted into the broadcast at distribution points in a nationwide television network. For example, during the Super Bowl, images of the game recorded by video cameras in the stadium are distributed to network affiliates in various regions throughout the nation. A network affiliate in Milwaukee may insert virtual beer advertisements into the network feed of the game before broadcasting it to their viewers, while an affiliate in Sunnyvale might insert advertisements for personal computers. This allows advertising to be tailored to the interests of each viewing audience, making it more cost effective.

Compared to television, the Internet is an underutilized resource for advertising. Presently, the amount of money spent for Internet advertising is not commensurate with the amount of time people spend online. Among the reasons for this is the fact that the present capabilities of Internet advertising are not as sophisticated as those of TV. Television advertising relies on the presentation of familiar visual images—logos, trademarks, etc. As stated above, the advent of virtual advertising has allowed these images to become even more easily included in TV broadcasts. In contrast, the transportation and manipulation of graphic images over the Internet has been more difficult. Most Internet connections lack the bandwidth to readily transmit the large amounts of data associated with graphic images. In part, this is due to the fact that most web images are based on bit-mapped graphics.

A bit-mapped image comprises a set of pixels, each of which represents the brightness and/or color of a small segment of the image. Greater detail in the image is obtained by dividing it into a greater number of smaller segments. However, this also increases the size (i.e., number of bytes required for storage) of the bit-mapped image. For this reason, high quality bit-mapped images are not well suited for transfer over the Internet. A number of compression algorithms have been developed, which can reduce the size of bit-mapped image files considerably. Compressed graphic file formats based on these algorithms (e.g., JPEG, GIF, PNG, etc.) are widely used. Nevertheless, graphic images still account for almost half of all Internet traffic.

To a great extent, the limitations of bit-mapped images restrict the capabilities of the Internet to support advertising. As stated above, since bit-mapped image files are often very large, web pages with bit-mapped graphic images can take a long time to draw. Furthermore, bit-mapped images are not readily scalable, and will not appear the same on computer monitors with different screen resolutions, or when printed at different scale factors. Moreover, many desirable features, such as interactivity, are difficult or impossible to implement with bit-mapped images.

In recognition of the shortcomings of traditional bit-mapped graphics, the World Wide Web Consortium (W3C), an association of major computer hardware and software manufacturers, has been working to develop new standards for graphic images on the Internet, based on scalable vector graphics technology. As used herein, the term SVG is meant to include not only the SVG language but other vector graphic languages such as postscript, PDF, etc

Scalable vector graphics is a method of representing graphic images parametrically, in terms of statements about fundamental graphic objects. Consider an image of a simple geometric shape, such as red circle. The bit-mapped graphic representation of this image would consist of a set of pixels, most of which would correspond to the background and a few of which would correspond to the red perimeter of the circle. The scalable vector graphics representation of the same circle would be a statement defining the diameter of the circle, the location of its center, and assigning it a red color attribute.

Scalable vector representation of objects has been widely used in computer assisted drafting (CAD) programs, where the ability to zoom to larger or smaller views of vector-based objects with no loss in precision is essential. More recently, similar techniques have been applied to the scalable representation of text and graphics in the Postscript printer language, or the Portable Document Format (PDF) language. The W3C is currently developing industry standards for scalable vector graphics in web-based applications, including SVG, a language supporting scalable vector graphics.

SVG is a vector graphics language, created to provide high-resolution graphics, animation, and interactivity on the web. It is based on the Extensible Markup Language (XML), the successor to HyperText Markup Language (HTML) for the design of next-generation web pages. All SVG statements refer to graphics elements, which comprise shapes, text or graphics referencing elements. A shape, in turn, consists of a basic shape combined with a path. The position and size of SVG graphics elements are defined relative to an arbitrary rectangular coordinate system, with its origin in the upper left comer. By multiplying or dividing all the coordinates by the same factor, we can easily enlarge or reduce the size of an SVG image. The following are examples of basic SVG shapes:

| | BASIC | |
|---|---|---|
| ELEMENT | ATTRIBUTES | NOTES |
| Rect | x, y, height, | also optional rx, ry, for rectangles with |
| | width | rounded corners |
| Circle | cx, cy, r | center (x, y) and radius |
| Ellipse | cx, cy, rx, ry | center (x, y) and x/y radius of ellipse |
| Line | x1, y1, x2, y2 | start and endpoints of line |
| Polyline | points list | x-y coordinate pairs, separated by spaces |
| | | or commas |
| Polygon | points list | x-y coordinate pairs |

The text element consists of a string together with an x-y coordinate pair defining the position of the string. Graphics referencing elements allow embedding bit-mapped graphic images in an SVG image, and consist of an x-y coordinate pair, height and width of the desired image, and a link to the file containing the bit-mapped image.

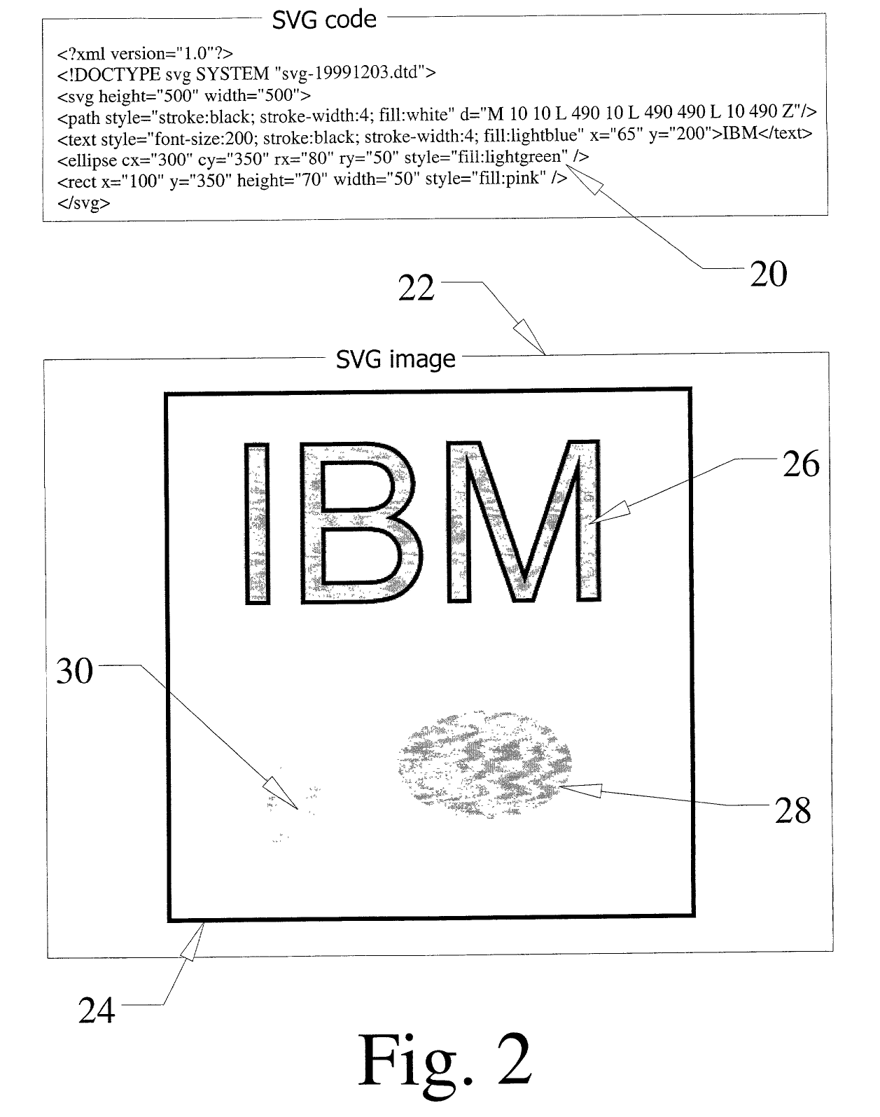

An example of the use of SVG is shown in FIG. 2. The SVG statements 20 shown in the upper part of the page result in the image 22 shown in the lower portion of the page. The third statement:

<svg height=“500”width=“500”>

defines the extent of the image. The locations and sizes of graphic objects specified in subsequent SVG statements are relative to this coordinate frame. For example, the fourth SVG statement:

<path style=“stroke:black; stroke-width:4; fill:white”d=“M 10 10L 490 10L490 490L10 490Z”/>

creates a rectangle 24 from four line segments, specified in terms of x-y coordinate pairs and lengths. The expression M 10 10 is interpreted as “move to location (10, 10)”, and the expression L 490 10 is interpreted as “draw a line from the present location to location (490, 10)”. The “style” component of this statement defines the width and color of the line.

Similarly, the sixth SVG statement:

<ellipse cx=“300”cy=“350”rx=“80”ry=“50”style=“fill:lightgreen”/>

defines an ellipse 28 in terms of the x-y coordinates of its center (300 and 350, respectively), and its x and y radii (80 and 50, respectively). Since the coordinate frame extends from (x, y) =(0, 0) to (x, y) =(500, 500), specifying the ellipse center at (x, y)=(300, 350) places the ellipse somewhat below and to the right of the middle of the frame. A “style” attribute included in the above SVG statement causes the ellipse to be filled with a light green solid pattern. In a similar manner, the seventh statement (i.e., <rect x=“100”cy=“350”height=“70”width=“50”style=“fill:pink”/>) defines the size, location and color of a small rectangle 30. In addition to geometric shapes and line segments, text is an SVG primitive element. The fifth SVG statement in FIG. 2 defines the font size, color, fill-style, etc. of a text element 26 representing the IBM logo.

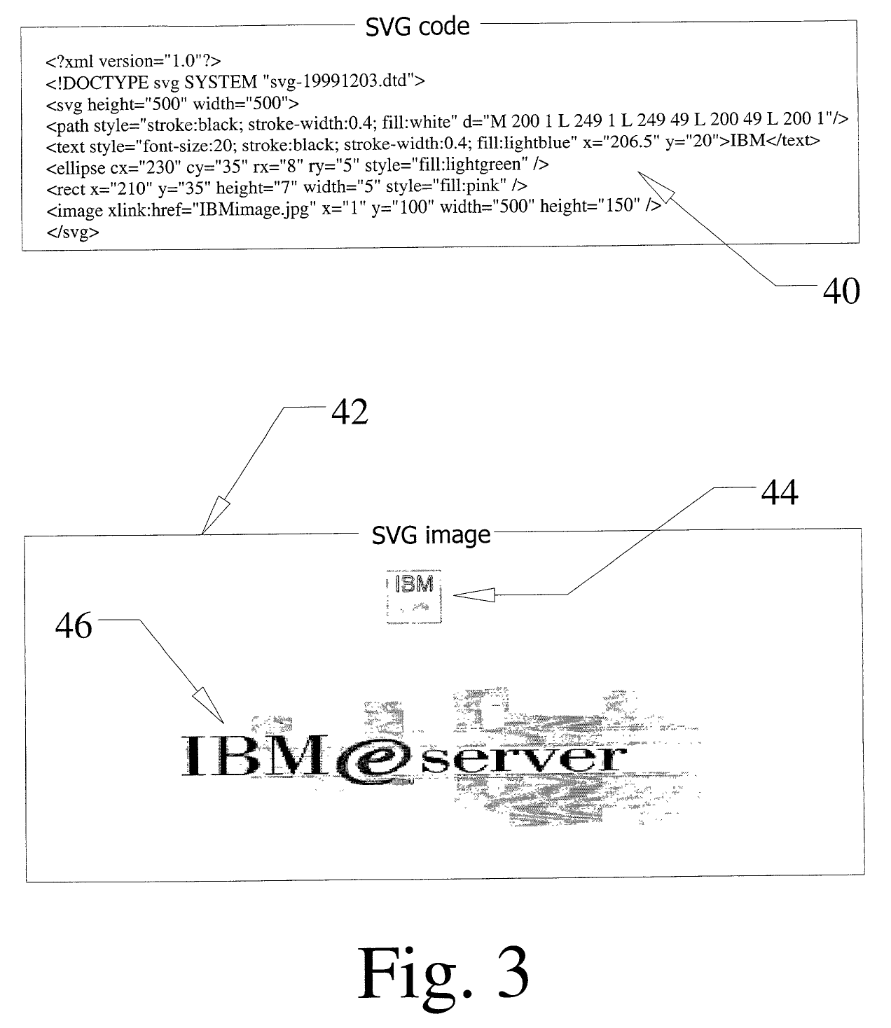

The scalability of SVG graphic images makes it simple to shrink or enlarge them to fit an available area of the web page. This is a significant advantage over bit-mapped images, which are not readily scalable. Since the sizes and locations of all the objects are given in terms of the coordinate frame, a simple linear transformation can be used to rescale an SVG image, with no loss in image quality. Furthermore, references to bit-mapped images can be embedded in SVG statements, permitting bit-mapped images to be combined with vector-scalable images on the same page. These features are illustrated in FIG. 3.

The SVG code 40 in FIG. 3 is similar to that of FIG. 2, and results in the graphic image 42. One difference between the SVG code in FIG. 3 40 and that of FIG. 2 20 is that the coordinates specifying the locations and sizes of the rectangular box and the objects appearing within it have been scaled and shifted. For example, the fourth SVG statement:

<path style=“stroke:black; stroke-width:0.4; fill:white”d=“M200 1L249 1L249 49L200 49L200 1 ”/>

draws the first of four line segments defining the rectangular box from (x, y)=(200, 1) to (x, y)=(249, 1). Thus, the length of this side of the rectangle has been shrunk from 490 to 49, and its starting position shifted from 10 to 200. Other coordinates have been transformed in the same manner. A multiplicative scaling operation followed by an additive shifting operation resizes the graphic image of FIG. 2, yielding the compact image 44.

A second difference between the SVG code 40 in FIG. 3 and that of item 20 of FIG. 2 is the eighth SVG statement:

<image xlink:href=“IBMimage.jpg”x=“1”y=“100”width=“500”height=“150”/>

This statement refers to a bit-mapped image file (IBMimage.jpg), and specifies the location of the image 46 within the 500×500 coordinate frame, as well as its height and width.

Note that, since SVG commands are text-based, they are less compact than binary files. But this also renders SVG programs readable and easy to edit, making it quite simple to modify SVG images. In the example above, the inclusion of a bit-mapped image with the SVG image required nothing more than the addition of a single statement to the existing SVG program. SVG image files can even contain URL links to other SVG image files.

Scalable SVG graphics will greatly enhance the functionality of web pages, by allowing zooming and panning of web images, as well as animation and other image transformations. This enhanced functionality can be applied in the creation of highly engaging web advertisements. Because SVG is fully compatible with the eXtended HyperText Markup Language (XHTML), it may be readily integrated into web pages. In fact, limited support for SVG is already present in current versions of the popular Internet browsers, such as Internet Explorer 5.0 and Netscape Navigator 4.0.

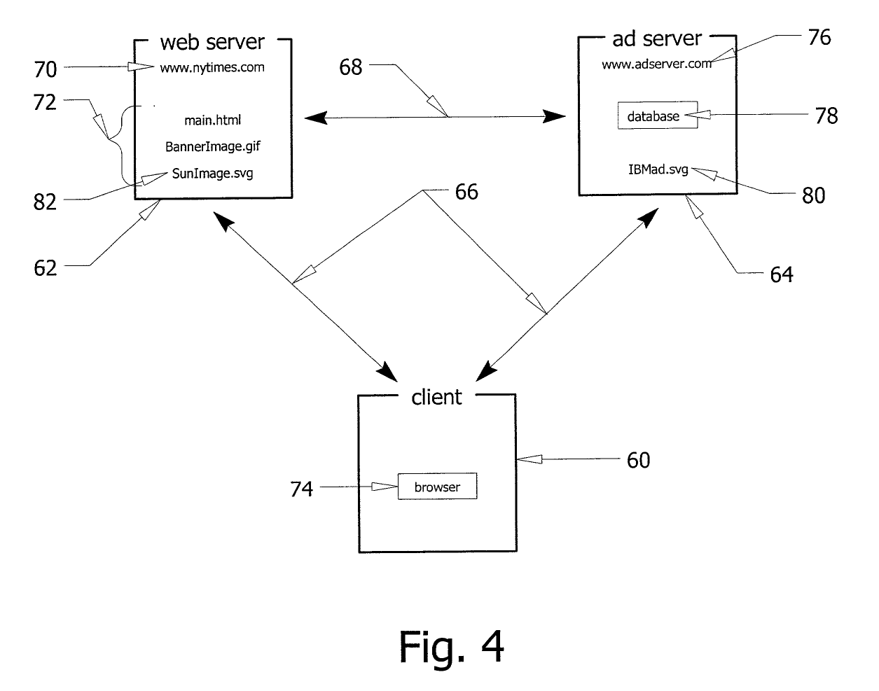

A system and method for virtual advertising on the web are disclosed herein. The basic configuration for implementing this system and method, as shown in FIG. 4, involves a client 60, a web server 62 and an ad server 64. The client communicates with web server 62 and ad server 64 via the Internet 66. In addition, the web server and ad server communicate over a high-speed network 68. In the most typical scenario, the client 60 requests a web page from the web server 62 via the Internet 66. The ad server 64 supplies the virtual advertising content that appears as part of the web page when it is received by the client 60. It is noted that web server 62 and ad server 64 can exist in the same location, or separated by a network connection. Thus, web server 62 is simply an execution unit that can be connected to another execution unit (ad server) 64 by a bus. If placed a disparate locations, the network connection can be an intranet or an internet, depending on the degree by which they are separated.

The web server supports an Internet address 70 (i.e., a website), at which the web page 72 sought by the client resides. Web page 72 contains a mixture of text and graphics, including a primary SVG image 82. The web page and its contents are interpreted by the client's browser 74. The ad server 64 has its own Internet address 76. It also has an SVG graphic image 80 comprising a virtual advertisement. By prior arrangement, the ad server is permitted to insert the virtual advertisement into certain web pages at specific locations. As part of this arrangement, a database 78 is created in the ad server 64, associating web pages with advertisements. Database 78 also contains such information as the region within the web page allocated for the ad, size of the ad, etc. When a web page is requested by the client, the database is consulted to determine whether a virtual advertisement should be inserted into the web page—and if so, which ad to insert and where to place it. The information in the database may reflect marketing decisions, based on geographic region, shopping season, etc. Random associations may be also be used, so that the virtual advertisement varies each time the web page is requested.

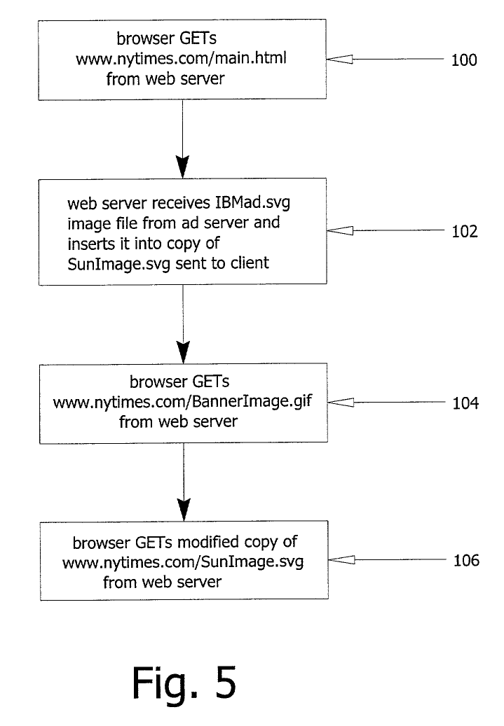

A first embodiment of the system and method is presented in the form of a flowchart in FIG. 5. The following explanation also makes reference to the basic configuration of FIG. 4. When a client browser requests a web page (using the HTTP “GET” command), the associated web server (item 62 in FIG. 4) sends 100 the main HTML page to the client (item 60 in FIG. 4). The main HTML page contains links to graphic image files. Before the client can display the requested page, it must also “GET”the embedded graphic images, including the primary SVG image (item 82 in FIG. 4). Prior to sending the SVG image to the client, the web server requests the virtual advertisement 102 (also in the form of an SVG image file) from the ad server (item 64 in FIG. 4). The ad server consults its database (item 78 in FIG. 4) to determine which virtual advertisement to use, and sends it to the web server. Because the high-speed network (item 68 in FIG. 4) connecting the ad server to the web server is typically much faster than the Internet connection to the client (item 66 in FIG. 4), this transfer does not contribute appreciably to the delay the user experiences in receiving the web page. Using the virtual advertisement SVG image file received from the ad server, an editor in the web server modifies the primary SVG image file so that the virtual advertisement overlays a portion of the original image. The client browser then GETs the GIF image 104 and the SVG image 106 from the web server. However, in place of the original primary SVG image (item 82 in FIG. 4), his browser displays the modified version of the image containing the virtual advertisement inserted by the web server.

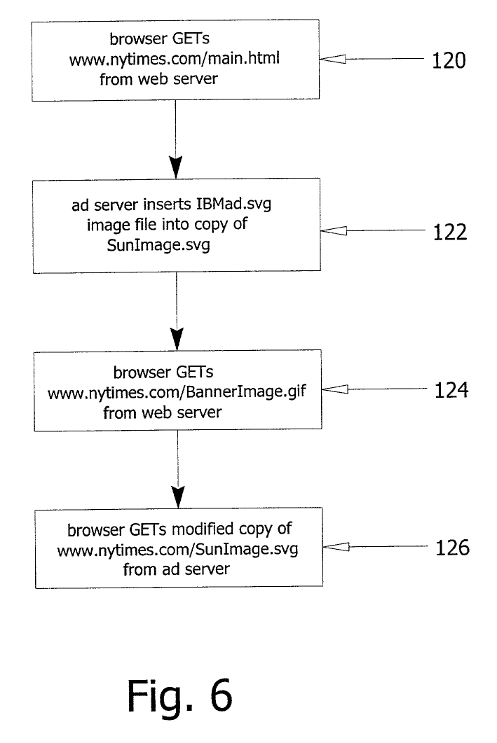

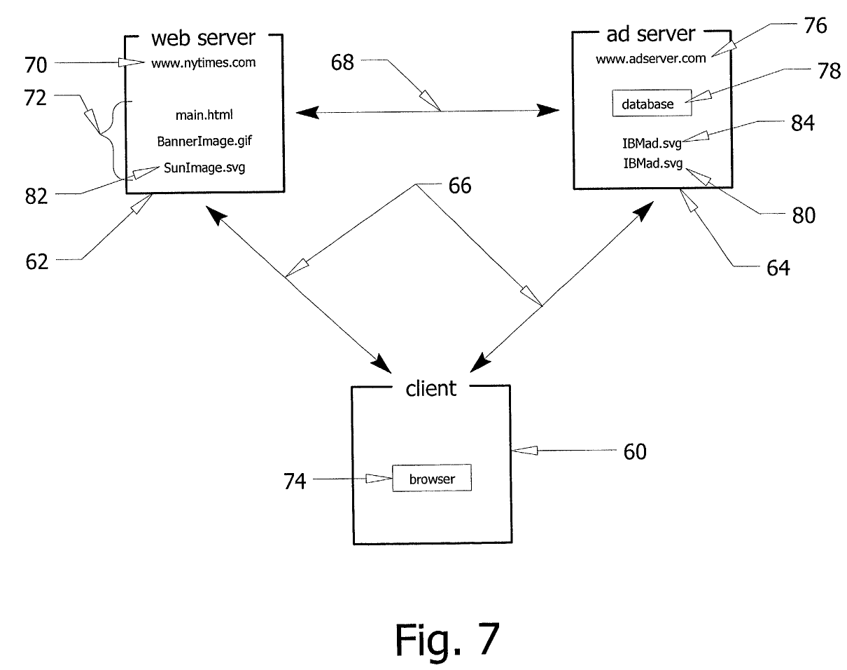

A second embodiment of the system and method is shown in the flowchart of FIG. 6. The following explanation also makes reference to the configuration diagram of FIG. 7. Note that FIG. 7 is quite similar to FIG. 4, and the same reference numbers are used to designate items common to both FIG. 4 and FIG. 7. As in the previous embodiment, the sequence of events begins when the client browser requests and GETs 120 a web page, containing a link to an SVG image file, from the web server. In this case, however, the link is to a copy of the primary SVG image (item 84 in FIG. 7) residing in the ad server. This copy was provided to the ad server through some prior arrangement with the web server. After consulting its database, the ad server edits its copy of the primary SVG image file 122 so that a portion of the original image is overlaid with the appropriate virtual advertisement (item 80 in FIG. 7). Upon receiving the main page, the browser uses the embedded links to retrieve the graphic content on the page. The browser obtains the bit-mapped image 124 from the web server, and the modified SVG image 126 from the ad server.

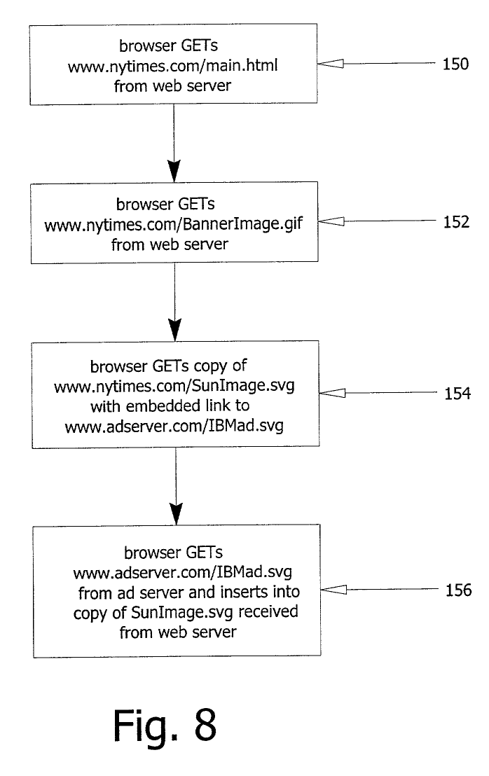

A third embodiment of the system and method is displayed in FIG. 8. The following explanation also makes reference to the configuration drawing in FIG. 4. As in the previous two embodiments, the sequence of events begins when the client browser requests and receives 150 the main web page (item 72 in FIG. 4) from the web server. As before, the main page contains links to graphic image files, allowing the browser to GET the images. Using one of the embedded links, the browser retrieves 152 a bit-mapped GIF file from the web browser. Another embedded link is used to retrieve 154 an SVG image file (item 82 in FIG. 4) from the web server. In this embodiment, the primary SVG image file from the web server contains a link to a virtual advertisement SVG image file (item 80 in FIG. 4) in the ad server. Thus, after the browser obtains the primary SVG image file from the web server, it GETs 156 the virtual advertisement SVG image file from the ad server. An editor in the client then modifies the primary SVG image file, overwriting a portion of the image. When the browser displays the web page, the virtual advertisement will be superimposed over part of the original SVG image (item 82 in FIG. 4) received from the web server.

The three embodiments described above differ mainly in which of the participants (i.e., client, web server or ad server) edits the primary SVG image file to insert the virtual advertisement content into the original image. The flexibility of the SVG vector graphics language is such that it is not critical where this operation is performed. Therefore, preference for one embodiment over another will depend on other considerations. For example, the second embodiment requires the ad server to have its own copy of the original SVG image, so that it can insert a virtual advertisement into the image before delivering it to the client. However, some companies may not want to give out proprietary images to advertisers, and might consider the second embodiment less desirable than the other two. Noting from the example shown in FIGS. 2 and 3, a first image shown as item 42 in FIG. 3 can be overlayed by a second image shown as item 24 in FIG. 2. Superimposing item 24/44 onto item 42 occurs by virtue of an editor which draws a first image and a second image from dissimilar execution units/storage devices and compiles one image onto the other. Although desirable, the images need not be scalable.

Those of ordinary skill in the art will appreciate that the hardware in which the invention is implemented may vary depending on the system implementation. For example, the system may have one or more processors, and other peripheral devices may be used in addition to or in place of the hardware mentioned above. In addition to being able to be implemented on a variety of hardware platforms, the present invention may be implemented in a variety of software and firmware embodiments.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

It will be appreciated by those skilled in the art having the benefit of this disclosure that this invention is believed to present improved techniques for caching dynamic web content. Further modifications and alternative embodiments of various aspects of the invention will be apparent to those skilled in the art in view of this description. Such details as the number of web servers, ad servers, and clients in the illustrative examples described herein represent a particular embodiment. It is intended that the following claims be interpreted to embrace all such modifications and changes and, accordingly, the specification and drawings are to be regarded in an illustrative rather than a restrictive sense.

What is claimed is:

1. A system for web-based virtual advertising, comprising:
a web server having a first vector graphics image and a web page containing a link to the first image;
an ad server operably coupled to the web server and having a second vector graphics image;
a client adapted to receive the web page from the web server and to receive the first and second images from the web server and the ad server, respectively; and
an editor adapted to overlay a portion of the first image with the second image.

2. The system as recited in claim 1, wherein the first image, second image or both the first and second images are scalable vector graphic images.

3. The system as recited in claim 1, wherein the web server receives the second image from the ad server, and wherein the editor operates within the web server to overlay a portion of the first image with the second image.

4. The system as recited in claim 1, wherein the ad server receives the first image from the web server, and wherein the editor operates within the ad server to overlay a portion of the first image with the second image.

5. The system as recited in claim 1, wherein the client receives the first image from the web server and receives the second image from the ad server, and wherein the editor operates within the client to overlay a portion of the first image with the second image.

6. The system as recited in claim 1, wherein the first and second images are represented as first and second files containing instructions in a vector graphic programming language.

7. The system as recited in claim 6, wherein overlaying a portion of the first image with the second image further comprises inserting instructions from the second file into the first file.

8. The system as recited in claim 1, wherein the client operates a web browser and is coupled via the Internet to the web server and the ad server.

9. The system as recited in claim 1, further comprising a database in the ad server, such that the database associates the second image with the first image.

10. The system as recited in claim 9, wherein the database specifies the location and size of the portion of the first image to be overwritten by the second image.

11. The system as recited in claim 10, wherein the location and size of the portion of the second SVG image to be overwritten by the second SVG image are determined by a computer program.

12. The system as recited in claim 1, wherein the web server and ad server are computer program execution units adapted to transmit, receive and process data stored in a carrier medium adapted for transmission therebetween.

13. A method for web-based virtual advertising, comprising:
requesting a web page from a first computer containing a link to a first vector graphics image;
overlaying a portion of the first image with a second vector graphics image obtained from a second computer to obtain a modified first image; and
displaying the modified first image.

14. The method as recited in claim 13, wherein the first image, second image or both the first and second images are scalable vector graphic images.

15. The method as recited in claim 13, wherein the first and second images are represented as first and second files containing instructions in a vector graphic programming language.

16. The method as recited in claim 15, wherein said overlaying comprises using an editor to insert instructions from the second file into the first file.

17. The method as recited in claim 16, wherein said overlaying comprises operating the editor within the first computer to overlay a portion of the first image with the second image.

18. The method as recited in claim 16, wherein said overlaying comprises operating the editor within the second computer to overlay a portion of the first image with the second image.

19. The method as recited in claim 16, wherein said overlaying comprises operating the editor within a client operably linked to the first computer and the second computer to overlay a portion of the first image with the second image.

20. A computer-usable carrier medium, comprising:
first program instructions for linking a first vector graphics image from a web page residing on a first computational device; and
second program instructions for fetching a second vector graphics image from a second computational device and compiling the second image onto the first image.

21. The computer-usable carrier medium as recited in claim 20, wherein the first image, second image or both the first and second images are scalable vector graphic images.

22. The computer-usable carrier medium as recited in claim 20, wherein the first and second program instructions reside on the first computational device, the second computational device, or both.

23. The computer-usable carrier medium as recited in claim 20, wherein the first and second program instructions comprise a database for compiling the first image with the second image.

24. The computer-usable carrier medium as recited in claim 23, wherein the database is operably accessed to specify the location and size of the portion of the first image to be overwritten by the second image.

25. The computer-usable carrier medium as recited in claim 20, further comprising a third program instruction for determining the location and size of a portion of the first image to be overwritten by or superimposed upon the second image.
